(19) United States
(12) Patent Application Publication
(10) Pub. No.: US 2007/0087936 A1
(43) Pub. Date: Apr. 19, 2007

(54) Recording medium and method of manufacturing inkjet recording medium

(75) Inventors: Kentaro Shiratsuchi, Shizuoka-ken (JP); Tomoya Kubota, Shizuoka-ken (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation

(21) Appl. No.: 11/544,664

(22) Filed: Oct. 10, 2006

(30) Foreign Application Priority Data
Oct. 14, 2005 (JP) 2005-300940

(51) Int. Cl. B41M 5/24

(52) U.S. Cl. 503/201

(57) ABSTRACT

Provided is a recording medium having, on a support, a recording layer including a tartaric acid diamide derivative having an alkenyl group and/or an alkynyl group. The tartaric acid diamide derivative is preferably represented by any of the following formulae (1) to (3). R₁ to R₁₂ each independently represent a hydrogen atom, an alkenyl group having 2 to 30 carbon atoms, or an alkynyl group having 2 to 30 carbon atoms. R₁ to R₁₂ may be the same as or different from each other. At least one of R₁ to R₄ represents an alkenyl group or an alkynyl group, at least one of R₅ to R₈ represents an alkenyl group or an alkynyl group, and at least one of R₉ to R₁₂ represents an alkenyl group or an alkynyl group.

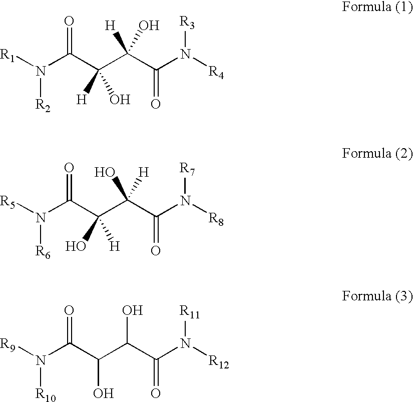

### CROSS-REFERENCE TO RELATED APPLICATIONS

This application claims priority under 35 USC 119 from Japanese patent Application No. 2005-300940, the disclosure of which is incorporated by reference herein.

### BACKGROUND OF THE INVENTION

1. Field of the Invention

The present invention relates to a recording medium that is used suitably in an inkjet recording method, particularly a recording medium which is excellent in ozone resistance.

2. Description of the Related Art

In recent years, a variety of information processing systems such as an inkjet recording method, a thermal recording method, a pressure sensitive recording method, a photosensitive recording method, and a transfer-type recording method have been developed with rapid advancements in information-technology industry; and recording methods and recording instruments suitable for these information processing systems have also been developed and put into practical use.

Among others, the inkjet recording method has been used widely in home use in addition to office use as a matter of course, in view of such advantages as capability of recording on a variety of recording materials, relatively inexpensive and compact hardware (apparatus), and excellent quietness.

With an increase in resolution of inkjet printers in recent years, it has become possible to obtain a high-quality recorded material, a so-called photo-like recorded material. A variety of recording sheets for inkjet recording have been developed also with such progress of hardware (apparatuses) as mentioned above.

Characteristics required for a recording medium for inkjet recording include commonly (1) quick-drying (high ink absorption rate), (2) adequate and uniform diameter of ink dots (no bleeding), (3) good graininess, (4) high circularity of dots, (5) high color concentration, (6) high color saturation (dullness-free), (7) excellent water resistance, light resistance, and ozone resistance of a printed area, (8) high whiteness of a recording sheet, (9) good storability of the recording sheet (no yellowing or discoloration even in long storage), and no bleeding in the image even during long storage (excellent suppression of bleed with time), (10) resistance to deformation and good dimensional stability (sufficiently small curl), and (11) good traveling performance in hardware.

In an application for photographic glossy paper which is used for the purpose of obtaining a so-called photo-like high-quality recording product, it is required for the paper to have glossiness, glossiness of printed area, surface smoothness, photographic paper-like feeling similar to silver salt photography, and the like, in addition to the above-described various characteristics.

For the purpose of improving the above-described various characteristics, an inkjet recording medium in which the recording layer has a porous structure has been developed and put into practical use in recent years. Since such an inkjet recording medium involves the porous structure, the recording medium is excellent in ink receiving property (quick-drying) and has high glossiness.

However, such recording sheets have a problem in that the gas permeability is high due to the porous film, which may accelerate the deterioration of the components contained in the recording layer.

A trace gas in the air, particularly ozone, can be a cause for fading of a recorded image over time. Since the recording materials having a recording layer of the above-mentioned porous structure have a lot of voids, the recorded image is easily faded by ozone in the air. Therefore, resistance to ozone gas (ozone resistance) is a very important characteristic for a recording material having a recording layer of the above-described porous structure.

Therefore, many inkjet recording media for improving the ozone resistance have been proposed. For example, an inkjet recording medium having an ink-receiving layer containing inorganic pigment fine particles, a tocopherol derivative, and a flavonoid (see Japanese Patent Application Laid-Open (JP-A) No. 2002-283710), an inkjet recording medium having an ink-receiving layer containing a triazine compound having an alkenyl group and/or an alkynyl group (refer to JP-A No. 2004-90228), an inkjet-recording medium having an ink-receiving layer containing an amino compound having an alkenyl group and/or an alkynyl group (refer to JP-A No. 2004-98609), an inkjet recording medium having an ink-receiving layer containing an alkenylsulfonic acid, an alkynylsulfonic acid, or a derivative thereof (refer to JP-A No. 2004-181748), an inkjet recording medium having an ink-receiving layer containing isocyanuric acid or a derivative thereof (refer to JP-A No. 2004-188666), and an inkjet recording medium including a compound having an alkenyl group (refer to JP-A No. 2005-153315), have been proposed.

However, there is yet room for improvement in the ozone resistance of these inkjet recording media and it has been difficult to sufficiently suppress the decrease in image concentration caused by ozone.

### SUMMARY OF THE INVENTION

The present invention has been made in consideration of the above situation, and provides a recording medium and a method of manufacturing an inkjet recording medium.

An aspect of the invention is to provide a recording medium having a recording layer on a support. The recording layer includes a tartaric acid diamide derivative having an alkenyl group and/or an alkynyl group.

### DETAILED DESCRIPTION OF THE INVENTION

The present invention provides a recoding medium having a recording layer that contains a tartaric acid diamide derivative having an alkenyl group and/or an alkynyl group. The alkenyl group is preferably an alkenyl group having 2 to 30 carbon atoms, and the alkynyl group is preferably an alkynyl group having 2 to 30 carbon atoms.

The tartaric acid diamide derivative is preferably selected from the following Formulae (1) to (3).

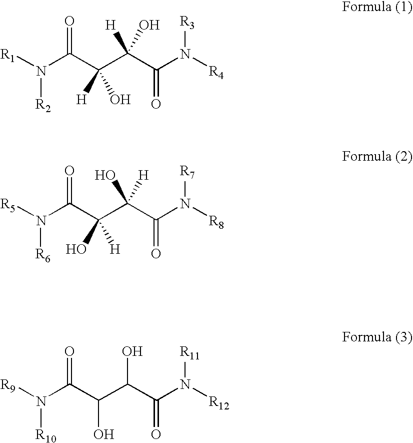

In the formulae (1) to (3), R₁ to R₁₂ each independently represent a hydrogen atom, an alkenyl group having 2 to 30 carbon atoms, or an alkynyl group having 2 to 30 carbon atoms. R₁ to R₁₂ may be the same as or different from each other. At least one of R₁ to R₄ represents an alkenyl group or an alkynyl group, at least one of R₅ to R₈ represents an alkenyl group or an alkynyl group, and at least one of R₉ to R₁₂ represents an alkenyl group or an alkynyl group.

When any of R₁ to R₁₂ represents an alkenyl group, the alkenyl group may be straight chain, branched, or cyclic, and may be substituted or unsubstituted. The alkenyl group preferably has 2 to 30 carbon atoms, and more preferably 2 to 20 carbon atoms. The preferred range of the number of carbon atoms of the alkenyl part of a substituted alkenyl group is the same as that of an alkenyl group.

Specific examples of the alkenyl group include a vinyl group, a propenyl group, an allyl group, an isopropenyl group, a 1-butenyl group, a 2-butenyl group, a 2-pentenyl group, a dodecenyl group, an octadecenyl group, a cyclopentenyl group, and cyclohexenyl group. In particular, a vinyl group, a propenyl group, an allyl group, and an isopropenyl group are preferable.

Examples of substituents on the above-mentioned substituted alkenyl group include a halogen atom (for example, a fluorine atom, a chlorine atom, or a bromine atom), a carboxy group, a sulfo group, a hydroxy group, an alkoxy group having 30 or fewer carbon atoms (for example, a metoxy group, an ethoxy group, a benzyloxy group, a phenoxyethoxy group, a phenethyloxy group, etc.), an acyl group having 30 or fewer carbon atoms (for example, an acetyl group, a propionyl group, a benzoyl group, etc.), and an aryl group having 30 or fewer carbon atoms (for example, a phenyl group, a 4-chlorophenyl group, a 4-methylphenyl group, an a-naphthyl group, etc.), wherein the carboxyl group, the hydroxy group, and the sulfo group each may form a salt. Examples of cations for forming the salt include an organic cationic compound and a metal cation.

Preferred alkenyl groups for R₁ to R₁₂ are the alkenyl groups shown in the following structural formulae (1) to (12). In particular, the groups of structural formulae (1), (2), (3), (9), and (10) are preferable and the allyl group of (1) is the most preferable.

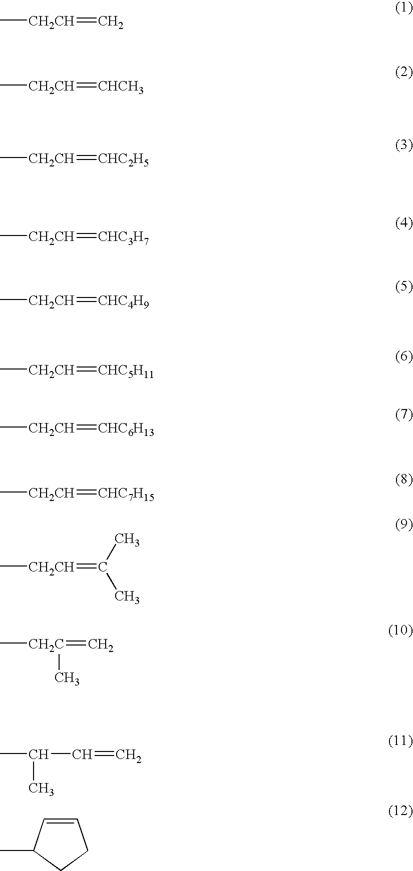

When any of R₁ to R₁₂ represents an alkynyl group, the alkynyl group may be substituted or unsubstituted, and examples include straight chain, branched, or cyclic alkynyl groups. R₁ to R₁₂ may form a ring with substituents adjacent to each other. The alkynyl group preferably has 2 to 30 carbon atoms, and more preferably 2 to 20 carbon atoms. The number of carbon atoms of the alkynyl part of the substituted alkynyl group is also preferably in the above range. Specific examples of the alkynyl group include an ethynyl group, a propargyl group, and a trimethylsilylethynyl group.

Preferable examples of the tartaric acid diamide derivative including an alkenyl group and/or an alkynyl group used in the invention are shown below, but the invention is not limited thereto.

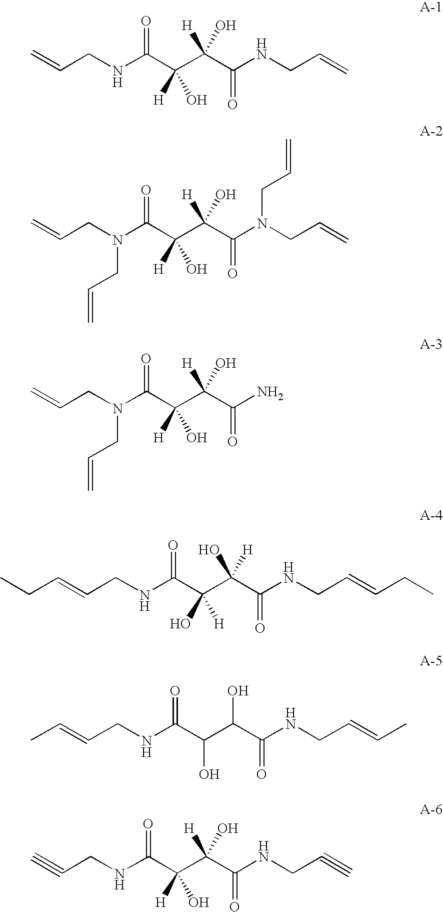

These tartaric acid diamide derivatives can be used after being dissolved in water. Specifically, a recording medium can be obtained by adding the tartaric acid diamide derivative to an aqueous coating liquid, applying the coating liquid onto a support, and drying the coated liquid. The tartaric acid diamide derivative is included in at least one layer on the support, specifically in any of a recording layer, a protective layer, an undercoating layer, an intermediate layer, or the like. In order to obtain the effect of the invention effectively, the tartaric acid diamide derivative is preferably included in the recording layer and/or the protective layer, most preferably in the recording layer.

The amount of the tartaric acid diamide derivative in the recording medium is preferably 0.1 to 2.0 g/m², more preferably 0.1 to 1.0 g/m², and further preferably 0.2 to 0.6 g/m².

[Inorganic Fine Particles]

Examples of the inorganic fine particles include silica fine particles, colloidal silica, titanium dioxide, barium sulfate, calcium silicate, zeolite, kaolinite, halloysite, mica, talc, calcium carbonate, magnesium carbonate, calcium sulfate, pseudo-boehmite, zinc oxide, zinc hydroxide, alumina, aluminum silicate, calcium silicate, magnesium silicate, zirconium oxide, zirconium hydroxide, cerium oxide, lanthanum oxide, and yttrium oxide. Silica fine particles, colloidal silica, alumina fine particles and pseudo-boehmite are preferable among them from the viewpoint of forming a good porous structure. The fine particles may be used as primary particles, or after forming secondary particles. The average primary particle diameter of these fine particles is preferably 2 μm or less, more preferably 200 nm or less.

Furthermore, silica fine particles with an average primary particle diameter of 20 nm or less, colloidal silica with an average primary particle diameter of 30 nm or less, alumina fine particles with an average primary particle diameter of 20 nm or less, and pseudo-boehmite with an average fine pore diameter of 2 to 15 nm are more preferable, and the silica fine particles, alumina fine particles and pseudo-boehmite are particularly preferable.

The silica fine particles are roughly classified into wet method particles and dry method (gas phase method) particles depending on their production method. In a typical example of the wet method, active silica is formed by acidolysis of a silicate salt, and active silica is polymerized to an adequate degree, and then is coagulated and precipitated to form hydrated silica. In contrast, in a typical example of the gas phase method, anhydrous silica is obtained by hydrolysis of silicon halide in gas phase at high temperature (flame hydrolysis method), or silica sand and coke are vaporized by reduction by heating with arc in an electric furnace, and the product thereof is oxidized with air (arc method). The “gas phase silica” means anhydrous silica fine particles obtained by the gas phase method. The gas phase silica fine particles are particularly preferable as the silica fine particles used in the invention.

Although the gas phase silica exhibits different properties from hydrated silica due to the difference in the density of the silanol groups on the surface and in the proportion of the voids, the gas phase silica is suitable for forming a three-dimensional structure having a high void ratio. While the reason therefor is not clear, the reason is presumably as follows: the density of the silanol groups on the surface of the fine particles is as large as 5 to 8 groups/nm² in the case of hydrated silica, and thus the silica particles easily aggregate. In contrast, the density of the silanol group on the surface of the fine particles is as small as 2 to 3 groups/nm² in the case of gas phase silica, and thus the fine particles form coarse and soft aggregate (flocculate), thereby forming a structure having a high void ratio.

Since gas phase silica has a particularly large surface area, the efficiency for absorbing and retaining ink is high. In addition, owing to a low refractive index of gas phase silica, transparency can be rendered to the ink-receiving layer by dispersing the particles to an adequate particle diameter, whereby high color density and good coloring property can be obtained. The transparency of the receiving layer is important for obtaining a high color density and good glossiness of colors, not only in the uses requiring high transparency such as an OHP film, but also in an application as a recording sheet such as a photographic glossy paper.

The average primary particle diameter of the inorganic fine particles (e.g., gas phase silica) is preferably 50 nm or less, more preferably from 3 to 50 nm, still more preferably from 3 to 30 nm, particularly preferably 3 to 20 nm, and most preferably 3 to 10 nm, in view of the quick drying property (ink absorption rate). Since the gas phase silica particles are liable to be coagulated with each other due to hydrogen bonds between the silanol groups, a structure having a large void ratio can be formed when the average primary particle diameter is 50 nm or less, and ink absorbing characteristics can be effectively improved.

The gas phase silica may be used together with other inorganic fine particles such as those described above. The content of gas phase silica is preferably 30 mass % or more, more preferably 50 mass % or more, when the gas phase silica is used together with other fine particles.

Alumina fine particles, alumina hydrate, and a mixture or composite thereof are also preferable as the inorganic fine particles used in the invention. The alumina hydrate is preferable among them since it absorbs ink well and fixes the ink, and pseudo-boehmite (Al₂O₃.nH₂O) is particularly preferable. While various forms of the alumina hydrate may be used, boehmite sol is preferably used as the raw material since a smooth layer can be readily obtained.

The fine void structure of pseudo-boehmite preferably has an average fine void diameter of 1 to 30 nm, more preferably 2 to 15 nm. The fine void volume is preferably 0.3 to 2.0 cc/g, more preferably 0.5 to 1.5 cc/g. The fine void diameter and fine void volume are measured by a nitrogen absorption-desorption method using, for example, a gas absorption-desorption analyzer (for example, OMNISORP 369 manufactured by Beckman Coulter, Inc.).

The gas phase alumina fine particles are preferable among the alumna fine particles due to their large surface area. The average primary particle diameter of the gas phase alumina is preferably 30 nm or less, more preferably 20 nm or less.

When the fine particles are used in the inkjet recording medium, for example, embodiments disclosed in JP-A Nos. 10-81064, 10-119423, 10-157277, 10-217601, 11-348409, 2001-138621, 2000-43401, 2000-211235, 2000-309157, 2001-96897, 2001-138627, 11-91242, 8-2087, 8-2090, 8-2091, 8-2093, 8-174992, 11-192777 and 2001-301314 can also be used preferably.

[Water-Soluble Resin]

When the recording medium according to the invention is used as an inkjet recording medium, the recording layer preferably includes a water-soluble resin.

Examples of the water-soluble resin include polyvinyl alcohol resins (e.g., polyvinyl alcohol (PVA), acetoacetyl-modified polyvinyl alcohol, cation-modified polyvinyl alcohol, anion-modified polyvinyl alcohol, silanol-modified polyvinyl alcohol and polyvinyl acetal), which are resins having hydroxyl groups as hydrophilic structural units, cellulose resins (methyl cellulose (MC), ethyl cellulose (EC), hydroxyethyl cellulose (HEC), carboxymethyl cellulose (CMC), hydroxypropyl cellulose (HPC), hydroxyethylmethyl cellulose and hydroxypropylmethyl cellulose), chitins, chitosans, starches, resins having ether bonds (polyethylene oxide (PEO), polypropylene oxide (PPO), polyethyleneglycol (PEG) and polyvinyl ether (PVE)), and resins having carbamoyl groups (polyacrylamide (PAAM), polyvinyl pyrrolidone (PVP) and polyacrylic acid hydrazide).

Other examples include polyacrylic acid salts, maleic acid resins, and alginic acid salts, having carboxylic groups as dissociation groups, and gelatins.

The polyvinyl alcohol resins are particularly preferable among the resin above. Examples of the polyvinyl alcohol resins are described in Japanese Patent Application Publication (JP-B) Nos. 4-52786, 5-67432 and 7-29479, Japanese Patent No. 2537827, JP-B No. 7-57553, Japanese Patent Nos. 2502998 and 3053231, JP-A No. 63-176173, Japanese Patent No. 2604367, JP-A Nos. 7-276787, 9-207425, 11-58941, 2000-135858, 2001-205924, 2001-287444, 62-278080 and 9-39373, Japanese Patent No. 2750433, JP-A Nos. 2000-158801, 2001-213045, 2001-328345, 8-324105, and 11-348417.

Examples of water-soluble resins other than polyvinyl alcohol resins include the compounds described in paragraph [0011] to [0014] in JP-A No. 11-165461.

Only one water-soluble resin may be used, or a combination of two or more water-soluble resins may be used.

The content of the water-soluble resin of the invention is preferably 9 to 40 mass %, more preferably 12 to 33 mass %, relative to the mass of the total solid content of the ink-receiving layer.

The water-soluble resin and the inorganic fine particles, which are main constituents of the ink-receiving layer according to the invention, each may be composed of a single material, or a mixture of plural materials.

The kind of the water-soluble resin to be combined with the inorganic fine particles, particularly silica fine particles, is important from the viewpoint of maintaining transparency. When gas phase silica is used, the water-soluble resin is preferably a polyvinyl alcohol resin. In particular, the polyvinyl alcohol resin preferably has a saponification degree of 70 to 100%, more preferably 80 to 99.5%.

While the polyvinyl alcohol resin has hydroxyl groups in its structural units, a three dimensional network structure with secondary particles of the silica fine particles as network chain units is readily formed since hydrogen bonds are formed between the hydroxyl groups and the silanol groups on the surface of the silica fine particles. It is considered that an ink-receiving layer having a porous structure with a high void ratio and sufficient strength is formed owing to the formation of the three dimensional network structure.

The porous ink-receiving layer obtained as described above rapidly absorbs ink by capillary action during inkjet recording, and thus dots of good circularity can be formed without ink bleed.

The polyvinyl alcohol resin may be used together with other water-soluble resins. The content of polyvinyl alcohol resin in the total water-soluble resins is preferably 50 mass % or more, more preferably 70 mass % or more, when the polyvinyl alcohol resin is used together with other water-soluble resins.

<Composition Ratio Between Fine Particles and Water-Soluble Resin>

The mass composition ratio (PB ratio (x/y)) of inorganic fine particles (x) to water-soluble resin (y) largely affects the structure and strength of the ink-receiving layer. While the void ratio, fine void volume and surface area (per unit mass) increase as the mass composition ratio (PB ratio) increases, the density and strength tend to be lowered.

The mass composition ratio (PB ratio, (x/y)) in the ink-receiving layer of the invention is preferably in the range of 1.5 to 10, so as to prevent decrease in the layer strength and generation of cracks at drying resulting from an excessively large PB ratio, and so as to prevent decrease in ink absorbing property accompanying reduction of void ratio caused by easily occurring filling of voids with the resin resulting from an excessively small PB ratio.

Since the recording sheet may suffer stress when conveyed in a conveyer system of an inkjet printer, the ink-receiving layer should have sufficient film strength. Sufficient strength of the ink-receiving layer is required also for preventing cracks and peeling of the ink-receiving layer when the recording sheet is cut into smaller sheets. The mass ratio (x/y) is preferably 5 or less in consideration of the above situation, and is preferably 2 or more from the viewpoint of ensuring high speed ink absorption in the inkjet printer.

A three dimensional network structure with the secondary particles of the silica fine particles as the network chains is formed, for example, by preparing a coating liquid in which gas phase silica fine particles with an average primary diameter of 20 nm or less and a water-soluble resin are completely dispersed in water in a mass ratio (x/y) of 2 to 5, applying the coating liquid onto a support, and then drying the coated layer, whereby a light-transmitting porous layer with an average fine void diameter of 30 nm or less, a void ratio of 50 to 80%, a specific void volume of 0.5 ml/g or more, and a specific surface area of 100 m²/g or more can be readily formed.

(Crosslinking Agent)

When the recording medium according to the invention is used as an inkjet recording medium, the recording layer (ink-receiving layer) preferably includes a water-soluble resin. The recording layer (ink-receiving layer) is preferably a porous layer obtained by forming the coated layer containing the sulfoxide-containing compound, the cation polymer, the inorganic fine particles, the water-soluble resin and a crosslinking agent capable of crosslinking the water-soluble resin, and curing the coated layer through a crosslinking reaction between the crosslinking agent and the water-soluble resin.

Boron compounds are preferably used for crosslinking the water-soluble resin, particularly a polyvinyl alcohol resin. Examples of the boron compound include borax, boric acid, borate (for example orthoborate, InBO₃, ScBO₃, YBO₃, LaBO₃, Mg₃(BO₃)₂ and Co₃(BO₃)₂), diborate (for example Mg₂B₂O₅, CO₂B₂O₅), methaborate (for example, LiBO₂, Ca(BO₂)₂, NaBO₂ and KBO₂), tetraborate (for example Na₂B₄O₇.10H₂O), and pentaborate (for example KB₅O₈.4H₂O, Ca₂B₆O₁₁.7H₂O, and CsB₅O₅). Borax, boric acid and borates are preferable since they can cause crosslinking reaction quickly, and boric acid is particularly preferable.

The following compounds other than boron compounds may be used as the crosslinking agent for the water-soluble resin.

Examples of such other crosslinking agents include aldehyde compounds such as formaldehyde, glyoxal and glutaraldehyde; ketone compounds such as diacetyl and cyclopentanedione; active halogen compounds such as bis(2-chloroethylurea), 2-hydroxy-4,6-dichloro-1,3,5-triazine, 2,4-dichloro-6-S-triazine sodium salt; active vinyl compounds such as divinyl sulfonic acid, 1,3-divinylsulfonyl-2-propanol, N,N′-ethylenebis(vinylsulfonylacetamide), and 1,3,5-triaclyroyl-hexahydro-S-triazine; N-methylol compounds such as dimethylol urea and methylol dimethylhydantoin; melamine resins (for example, methylolmelamine, alkylated methylolmelamine); epoxy resins; isocyanate compounds such as 1,6-hexamethylene diisocyanate; aziridine compounds described in U.S. Pat. Nos. 3,017,280 and 2,983,611; carboxyimide compounds described in U.S. Pat. No. 3,100,704; epoxy compounds such as glycerol triglycidyl ether; ethylene imino compounds such as 1,6-hexamethylene-N,N′-bisethylene urea; halogenated carboxyaldehyde compounds such as mucochloric acid and mucophenoxy chloric acid; dioxane compounds such as 2,3-dihydroxydioxane, metal-containing compounds such as titanium lactate, aluminum sulfate, chromium alum, potassium alum, zirconium acetate and chromium acetate; polyamine compounds such as tetraethylenepentamine; hydrazide compounds such as adipic acid dihydrazide; and low molecular weight compounds or polymers containing at least two oxazoline groups.

Only a single crosslinking agent selected from the above may be used, or two or more crosslinking agents selected from the above may be used in combination.

As mentioned hereunder, crosslink curing is preferably carried out in the following manner: a crosslinking agent is added to a coating liquid containing inorganic fine particles, a water-soluble resin and the like (hereinafter occasionally referred to as “liquid A”) and/or to a the basic solution having a pH exceeding 7 (hereinafter occasionally referred to as “liquid B”); onto the coated layer formed by application of the liquid A, the liquid B is applied (1) simultaneously with the application of the liquid A for forming the coated layer, or (2) before the coated layer exhibits decreasing drying during drying of the coated layer formed by application of the liquid A. Application of the crosslinking agent is preferably conducted as follows when a boron compound is used as an example. Namely, if the ink-receiving layer is a layer obtained by crosslink-curing of a coated layer formed by application of the coating liquid (liquid A) containing fine particles and a water-soluble resin containing polyvinyl alcohol, the crosslink curing is carried out by applying the basic solution having a pH exceeding 7 (the liquid B) onto the coated layer (1) simultaneously with the application of the liquid A, or (2) before the coated layer exhibits decreasing drying during drying of the coated layer formed by application of the liquid A. The boron compound as a crosslinking agent may be contained at least one of the liquid A or the liquid B, and may be contained in the both of the liquids.

The amount of crosslinking agent to be used is preferably from 1 to 50 mass %, and more preferably from 5 to 40 mass % with respect to the water-soluble resin.

[Water-Soluble Polyvalent Metal Salt]

The recording layer (ink-receiving layer) in the invention preferably contains a water-soluble polyvalent metal compound. As the water-soluble polyvalent metal compound used in the invention, trivalent or higher multivalent metal compounds are preferable. The polyvalent metal compound may be, for example, a water-soluble salt of a metal selected from calcium, barium, manganese, copper, cobalt, nickel, aluminum, iron, zinc, zirconium, chromium, magnesium, tungsten, and molybdenum.

Specific examples thereof include calcium acetate, calcium chloride, calcium formate, calcium sulfate, calcium butyrate, barium acetate, barium sulfate, barium phosphate, barium oxalate, barium naphthoresorcin carboxylate, barium butyrate, manganese chloride, manganese acetate, manganese formate dihydrate, ammonium manganese sulfate hexahydrate, cupric chloride, ammonium copper (II) chloride dihydrate, copper sulfate, copper (II) butyrate, copper oxalate, copper phthalate, copper citrate, copper gluconate, copper naphthenate, cobalt chloride, cobalt thiocyanate, cobalt sulfate, cobalt (II) acetate, cobalt naphthenate, nickel sulfate hexahydrate, nickel chloride hexahydrate, nickel acetate tetrahydrate, ammonium nickel sulfate hexahydrate, amide nickel sulfate tetrahydrate, nickel sulfaminate, nickel 2-ethylhexanoate, aluminum sulfate, aluminum sulfite, aluminum thiosulfate, aluminum polychloride, aluminum nitrate nonahydrate, aluminum chloride hexahydrate, aluminum acetate, aluminum lactate, basic aluminum thioglycolate, ferrous bromide, ferrous chloride, ferric chloride, ferric sulfate, ferrous sulfate, iron (III) citrate, iron (III) lactate trihydrate, triammonium iron (III) trioxalate trihydrate, zinc bromide, zinc chloride, zinc nitrate hexahydrate, zinc sulfate, zinc acetate, zinc lactate, zirconium acetate, zirconium tetrachloride, zirconium chloride, zirconium oxychloride octahydrate, zirconium hydroxychloride, chromium acetate, chromium sulfate, magnesium acetate, magnesium oxalate, magnesium sulfate, magnesium chloride hexahydrate, magnesium citrate nonahydrate, sodium tungstophosphate, tungsten sodium citrate, dodecatungstophosphate n-hydrate, dodecatungstosilicate hexacosahydrate, molybdenum chloride, dodecamolybdophosphate n-hydrate and the like, aluminum alum, basic aluminum polyhydroxide, zinc phenolsulfonate, ammonium zinc acetate, and ammonium zinc carbonate. Two or more of these water-soluble polyvalent metal compounds may be used together.

Among the above-described water-soluble polyvalent metal compounds, an aluminum compound or a compound containing a metal belonging to Group 4A of the Periodic Table (for example, zirconium or titanium) is preferable, and an aluminum compound is more preferable. Particularly preferred is a water-soluble aluminum compound. The water-soluble aluminum compound may be an inorganic salt whose examples are aluminum chloride and hydrates thereof, aluminum sulfate and hydrates thereof, and aluminum alum, or a basic aluminum polyhydroxide compound, which is an inorganic aluminum-containing cationic polymer; they can be preferably used in the invention.

The basic aluminum polyhydroxide compound means a water-soluble aluminum polyhydroxide the major component of which is represented by the following formula 1, 2, or 3, and contains stably a basic and high-molecular polynuclear condensation ion such as [Al₆(OH)₁₅]³⁺, [Al₈(OH)₂₀]⁴⁺, [Al₁₃(OH)₃₄]⁵⁺, and [Al₂₁(OH)₆₀]³⁺.
[Al₂(OH)ₙCl₆₋ₙ]ₘ formula 1
[Al(OH)₃]ₙAlCl₃ formula 2
Alₙ(OH)ₘCl₍₃ₙ₋ₘ₎ 0<m<3n formula 3

These compounds are supplied from Tagi Chemical Co., Ltd. under the name of polyaluminum chloride (PAC) as a chemical for water treatment, from Asada Chemical Co., Ltd. under the name of polyaluminum hydroxide (Paho), from Riken Green Co., Ltd. under the name of HAP-25, from Taimei Chemicals Co., Ltd. under the name of ALUFINE 83, and from other manufacturers for the same purpose. Products of various grades are easily available.

As the water-soluble compound containing an element of Group 4A of the Periodic Table, water-soluble compounds containing titanium or zirconium are more preferable. Examples of a water-soluble compound containing titanium include titanium chloride, titanium sulfate, titanium tetrachloride, tetraisopropyl titanate, titanium acetylacetonate, and titanium lactate. Examples of a water-soluble compound containing zirconium include zirconium acetate, zirconium chloride, zirconium hydroxychloride, zirconium nitrate, basic zirconium carbonate, zirconium hydroxide, zirconium lactate, ammonium zirconium carbonate, potassium zirconium carbonate, zirconium sulfate, and zirconium fluoride compounds.

It is preferred that the water-soluble polyvalent metal compound is added in an amount of 0.1 to 10 mass %, and more preferably 0.5 to 8 mass % with respect to the inorganic fine particles.

[Mordant]

In the invention, it is preferred that the ink-receiving layer contains a mordant other than the water-soluble polyvalent metal compound in order to further improve the water resistance and the resistance to bleed over time of a formed image.

The mordant is preferably a cationic polymer (cationic mordant) that is an organic mordant, or an inorganic mordant. When the mordant is contained in the ink-receiving layer, the mordant interacts with an anionic dye contained as a colorant in liquid ink to stabilize the colorant, thereby improving the water resistance and the resistance to bleed over time. Organic mordants and inorganic mordants each may be used alone. In an embodiment, one or more organic mordants and one or more inorganic mordants are used in combination.

As the cationic mordant, a polymer mordant having, as a cationic group, a primary, secondary, or tertiary amino group or a quaternary ammonium base is used in general. However, the cationic mordant may be a cationic non-polymer mordant in the invention.

Examples of the polymer mordant include: homopolymers of a monomer (mordant monomer) having a primary, secondary, or tertiary amino group, or a salt thereof, or a quaternary ammonium base; copolymers or condensation polymers of the mordant monomer and one or more other monomers (hereinafter referred to as “non-mordant monomer”). These polymer mordants may be used in the form of a water-soluble polymer or water-dispersible latex particles.

Examples of the monomer (mordant monomer) include trimethyl-p-vinylbenzylammonium chloride, trimethyl-m-vinylbenzylammonium chloride, triethyl-p-vinylbenzylammonium chloride, triethyl-m-vinylbenzylammonium chloride, N,N-dimethyl-N-ethyl-N-p-vinylbenzylammonium chloride, N,N-diethyl-N-methyl-N-p-vinylbenzylammonium chloride, N,N-dimethyl-N-n-propyl-N-p-vinylbenzylammonium chloride, N,N-dimethyl-N-n-octyl-N-p-vinylbenzylammonium chloride, N,N-dimethyl-N-benzyl-N-p-vinylbenzylammonium chloride, N,N-diethyl-N-benzyl-N-p-vinylbenzylammonium chloride, N,N-dimethyl-N-(4-methyl)benzyl-N-p-vinylbenzylammonium chloride, and N,N-dimethyl-N-phenyl-N-p-vinylbenzylammonium chloride, trimethyl-p-vinylbenzylammonium bromide, trimethyl-m-vinylbenzylammonium bromide, trimethyl-p-vinylbenzylammonium sulfonate, trimethyl-m-vinylbenzylammonium sulfonate, trimethyl-p-vinylbenzylammonium acetate, trimethyl-m-vinylbenzylammonium acetate, N,N,N-triethyl-N-2-(4-vinylphenyl)ethylammonium chloride, N,N,N-triethyl-N-2-(3-vinylphenyl)ethylammonium chloride, N,N-diethyl-N-methyl-N-2-(4-vinylphenyl)ethylammonium chloride, N,N-diethyl-N-methyl-N-2-(4-vinylphenyl)ethylammonium acetate, N,N-dimethylaminoethyl(meth)acrylate, N,N-diethylaminoethyl(meth)acrylate, N,N-dimethylaminopropyl(meth)acrylate, N,N-diethyl aminopropyl(meth)acrylate, N,N-dimethylaminoethyl(meth)acrylamide, N,N-diethylaminoethyl(meth)acrylamide, N,N-dimethylaminopropyl(meth)acrylamide, N,N-diethylaminopropyl(meth)acrylamide, and salts thereof (for example, hydrochlorides, nitrates, acetates, lactates, methanesulfonates, p-toluenesulfonates and the like), trimethyl-2-(methacryloyloxy)ethylammonium chloride, triethyl-2-(methacryloyloxy)ethylammonium chloride, trimethyl-2-(acryloyloxy)ethylammonium chloride, triethyl-2-(acryloyloxy)ethylammonium chloride, trimethyl-3-(methacryloyloxy)propylammonium chloride, triethyl-3-(methacryloyloxy)propylammonium chloride, trimethyl-2-(methacryloylamino)ethylammonium chloride, triethyl-2-(methacryloylamino)ethylammonium chloride, trimethyl-2-(acryloylamino)ethylammonium chloride, triethyl-2-(acryloylamino)ethylammonium chloride, trimethyl-3-(methacryloylamino)propylammonium chloride, triethyl-3-(methacryloylamino)propylammonium chloride, trimethyl-3-(acryloylamino)propylammonium chloride, triethyl-3-(acryloylamino)propylammonium chloride, N,N-dimethyl-N-ethyl-2-(methacryloyloxy)ethylammonium chloride, N,N-diethyl-N-methyl-2-(methacryloyloxy)ethylammonium chloride, N,N-dimethyl-N-ethyl-3-(acryloylamino)propylammonium chloride, trimethyl-2-(methacryloyloxy)ethylammonium bromide, trimethyl-3-(acryloylamino)propylammonium bromide, trimethyl-2-(methacryloyloxy)ethylammonium sulfonate, and trimethyl-3-(acryloylamino)propylammonium acetate.

Examples of other mordant monomer include N-vinylimidazole, N-vinyl-2-methylimidazole, 2-vinylpyridine, 4-vinylpyridine, 4-vinyl-N-methylpyridinium chloride, 4-vinyl-N-ethylpyridinium bromide, dimethyldiallylammonium chloride, and monomethyldiallylammonium chloride.

Only one of such mordant monomers may be used, or two or more copolymerizable mordant monomers may be used in combination.

The non-mordant monomer refers to a monomer which does contain a basic or cationic portion such as a primary, secondary, or tertiary amino group or a quaternary ammonium salt, and which does not interact, or exhibit substantially small interaction, with the dye in ink-jet ink.

Examples of the non-mordant monomer include alkyl (meth)acrylates (for example an ester between C1-18 alkyl and (meth)acrylic acid, such as methyl(meth)acrylate, ethyl(meth)acrylate, propyl(meth)acrylate, isopropyl(meth)acrylate, n-butyl(meth)acrylate, isobutyl(meth)acrylate, t-butyl(meth)acrylate, hexyl(meth)acrylate, octyl(meth)acrylate, 2-ethylhexyl(meth)acrylate, lauryl(meth)acrylate and stearyl(meth)acrylate); cycloalkyl(meth)acrylates (such as cyclohexyl (meth)acrylate); aryl methacrylates (such as phenyl(meth)acrylate)); aralkyl(meth)acrylates (such as benzyl(meth)acrylate); substituted alkyl(meth)acrylates (such as 2-hydroxyethyl(meth)acrylate, methoxymethyl(meth)acrylate and allyl(meth)acrylate); (meth)acrylamides (such as (meth)acrylamide, dimethyl(meth)acrylamide, N-ethyl(meth)acrylamide, and N-isopropyl(meth)acrylamide); aromatic vinyls (styrene, vinyltoluene and α-methylstyrene); vinyl esters (such as vinyl acetate, vinyl propionate and vinyl versatate); allyl esters (such as allyl acetate); halogen-containing monomers (such as vinylidene chloride and vinyl chloride); vinyl cyanates (such as (meth)acrylonitrile); and olefins (such as ethylene and propylene).

Only one non-mordant monomer may be used, or two or more non-mordant monomers may be used in combination.

Examples of the polymer mordant include polyethyleneimine (and derivatives thereof), polyvinylamine (and derivatives thereof), polyallyamine (and derivatives thereof), polyamidine, cationic polysaccharides (such as cationic starch and chitosan), dicyan cationic resins (such as dicyan diamide-formalin polycondensate), polyamine cationic resins (such as dicyan diamide-diethylenetriamine polycondensate), epichlorohydrin-dimethylamine addition polymers, and dimethyldiallylammonium chloride-sulfur dioxide copolymer.

As the organic mordant in the invention, polymers having a quaternary ammonium base are preferable, and (meth)acrylate polymers, vinylbenzylammonium polymers and diallylammonium polymers having weight average molecular weight of 1,000 to 100,000 and having a quaternary ammonium base are particularly preferable.

In the invention, the content of the mordant in the ink-receiving layer is preferably from 0.01 to 10 g/m², more preferably from 0.1 to 5 g/m².

In the present invention, the coating liquid for forming an ink-receiving layer (coating liquid A) preferably contains a surfactant. As the surfactant, cationic surfactants, anionic surfactants, nonionic surfactants, amphoteric surfactants, fluorosurfactants, and silicone surfactants are all usable.

Examples of preferable nonionic surfactants include polyoxyalkylene alkylethers and polyoxyalkylene alkylphenylethers (such as diethyleneglycol monoethylether, diethyleneglycol diethylether, polyoxyethylene laurylether, polyoxyethylene stearylether and polyoxyethylene nonylphenylether); oxyethylene-oxypropylene block copolymers, sorbitan fatty acid esters (such as sorbitan monolaurate, sorbitan monooleate and sorbitan trioleate); polyoxyethylene sorbitan fatty acid esters (such as polyoxyethylene sorbitan monolaurate, polyoxyethylene sorbitan monoolelate and polyoxyethylene sorbitan trioleate); polyoxyethylene sorbitol fatty acid esters (such as tetra oleic acid polyoxyethylene sorbit); glycerin fatty acid esters (such as glycerol monooleate); polyoxyethylene glycerin fatty acid esters (such as monostearic acid polyoxyethylene glycerin and monooleic acid polyoxyethylene glycerin); polyoxyethylene fatty acid esters (such as polyethyleneglycol monolaurate, and polyethyleneglycol monooleate); polyoxyethylene alkylamines; and acetylene glycols (such as 2,4,7,9-tetramethyl-5-decyn-4,7-diol, and ethylene oxide adducts and propylene oxide adducts of the diol). Polyoxyalkylene alkylethers are preferable among them. The nonionic surfactant may be used in the liquid A and/or the liquid B. Only one nonionic surfactant may be used, or two or more nonionic surfactants may be used in combination.

Examples of amphoteric surfactants include those of amino acid type, carboxyamonium betaine type, sulfonammonium betaine type, ammonium sulfonic ester betaine type and imidazolium betaine type, and those described in U.S. Pat. No. 3,843,368, JP-A Nos. 59-49535, 63-236546, 5-303205, 8-262742 and 10-282619 may be favorably used. The amphoteric surfactant may be an amphoteric surfactant of amino acid type, which may be derived from an amino acid (such as glycine, glutamic acid or histidine) as described in JP-A No. 5-303205. Specifically, the amphoteric surfactant may be an N-aminoacyl acid having a long chain acyl group introduced thereto, or a salt thereof. Only a single amphoteric surfactant may be used, or two or more amphoteric surfactants may be used in combination.

Examples of anionic surfactants include fatty acid salts (for example, sodium stearate and potassium oleate), salts of alkylsulfuric acid esters (for example, sodium lauryl sulfate and triethanolamine lauryl sulfate), sulfonic acid salts (for example, sodium dodecylbenzene sulfonate), alkylsulfosuccinic acid salts (for example, sodium dioctylsulfosuccinate), alkyldiphenylether disulfonic acid salts, and alkylphosphoric acid salts.

Examples of cationic surfactants include alkylamine salts, quaternary ammonium salts, pyridinium salts and imidazolium salts.

Examples of fluorosurfactants include a compound derived from an intermediate having a perfluoroalkyl group using a method such as electrolytic fluorination, telomerization, or origomerization.

Examples of fluorosurfactants include perfluoroalkyl sulfonic acid salts, perfluoroalkyl carboxylic acid salts, perfluoroalkyl ethylene oxide adducts, perfluoroalkyl trialkyl ammonium salts, perfluoroalkyl group-containing oligomers, and perfluoroalkyl phosphoric acid esters.

The silicon surfactant is preferably a silicone oil modified with an organic group, which may have a structure in which a side chain of a siloxane structure is modified with the organic group, a structure in which the both terminals of a siloxane structure are modified with the organic group, or a structure in which one of the terminals of a siloxane structure is modified with the organic group. Examples of modification with the organic group include amino modification, polyether modification, epoxy modification, carboxyl modification, carbinol modification, alkyl modification, aralkyl modification, phenol modification and fluorine modification.

In the invention, the content of surfactant is preferably from 0.001 to 2.0%, more preferably from 0.01 to 1.0%, relative to the ink-receiving layer coating liquid (the liquid A). When two or more coating liquids for forming the ink-receiving layer are used for coating, it is preferable to add the surfactant to each coating liquid.

In the invention, the ink-receiving layer preferably contains a high boiling point organic solvent for preventing curling. The high boiling point organic solvent is an organic compound having a boiling point of 150° C. or higher at atmospheric pressure, and is a water-soluble or hydrophobic compound. The high boiling point organic solvent may be solid or liquid at room temperature, and may be a low molecular weight compound or a high molecular weight compound.

Examples of the high boiling point organic solvent include aromatic carboxylic acid esters (such as dibutyl phthalate, diphenyl phthalate and phenyl benzoate); aliphatic carboxylic acid esters (such as dioctyl adipate, dibutyl sebacate, methyl stearate, dibutyl maleate, dibutyl fumarate and triethyl acetylcitrate); phosphoric acid esters (such as trioctyl phosphate and tricresil phosphate); epoxy compounds (such as epoxylated soy bean oil and epoxylated fatty acid methyl esters); alcohols (such as stearyl alcohol, ethyleneglycol, propyleneglycol, diethyleneglycol, triethyleneglycol, glycerin, diethyleneglycol monobutylether (DEGMBE), triethyleneglycol monobutylether, glycerin monomethylether, 1,2,3-butanetriol, 1,2,4-butanetriol, 1,2,4-pentanetriol, 1,2,6-hexanetriol, thiodiglycol, triethanolamine and polyethyleneglycol); vegetable oils (such as soy bean oil and sunflower oil); and higher aliphatic carboxylic acid (such as linoleic acid and oleic acid).

<Support>

The support used in the invention may be a transparent support made of a transparent material such as plastics, or an opaque support made of an opaque material such as paper. A transparent support or a highly glossy opaque support is preferably used for taking advantage of transparency of the ink-receiving layer. In an embodiment, the support is a read-only optical disk such as a CD-ROM or a DVD-ROM, a write-once optical disk such as a CD-R and a DVD-R, or a rewritable optical disk, and the ink-receiving layer is provided on the label face side.

The material used for the transparent support is preferably transparent and resistant to radiant heat generated when used with an OHP or a backlight display. Examples of the material include polyesters such as polyethylene terephthalate (PET); polysulfone, polyphenylene oxide, polyimide, polycarbonate and polyamide. Polyesters are preferable, and polyethylene terephthalate is particularly preferable among them.

While the thickness of the support is not particularly restricted, the thickness is preferably 50 to 200 μm from the viewpoint of ease of the handling.

The opaque support having high glossiness preferably has a surface with a glossiness of 40% or more on which the ink-receiving layer is to be provided. The glossiness is measured according to the method (a 75 degree specular glossiness test method for paper sheets and paper board) defined in Japanese Industrial Standards (JIS) P-8142, which is incorporated herein by reference. Specific examples include the following supports.

Examples include highly glossy paper supports such as art paper, coat paper, cast-coat paper, and baryta paper used for silver salt photographic support; highly glossy films (which may have been subjected to a surface calendering treatment) comprising a plastic film that has been made opaque by adding a white pigment or the like, wherein the plastic film may be a polyester such as polyethylene terephthalate (PET), a cellulose ester such as nitrocellulose, cellulose acetate or cellulose acetate butylate, polysulfone, polyphenylene oxide, polyimide, polycarbonate or polyamide; and supports in which a coated layer of a polyolefin, which contains or does not contain a white pigment, on the surface of any of various paper supports as described above, a transparent support as described above, or a highly glossy film containing a white pigment or the like.

Foamed polyester films containing a white pigment (for example, foamed PET that contains polyolefin fine particles and voids formed by stretching) are also favorably used. Resin coat paper used for the silver salt photographic paper is also preferable.

While the thickness of the opaque support is not particularly restricted, it is preferably from 50 to 300 μm in consideration of ease of handling.

A corona discharge treatment, glow discharge treatment, flame treatment or UV irradiation treatment may be applied on the surface of the support for improving wettability and adhesive property.

The raw paper sheet used for the resin coat paper will be described in detail below.

The raw paper is produced using a wood pulp as a major material which may be added with a synthetic pulp such as polypropylene pulp, or synthetic fibers such as nylon or polyester fibers, as necessary. While any one of LBKP, LBSP, NBKP, NBSP, LDP, NDP, LUKP and NUKP may be used as the wood pulp, it is preferable to use a greater amount of LBKP, NBSP, LBSP, NDP and LDP, which contain a high proportion of short fibers, than other wood pulps.

However, the proportion of LBSP and/or LDP is preferably 10 mass % to 70 mass %.

Chemical pulps (such as sulfate pulp and sulfite pulp) containing little impurity may be preferably used, and a pulp whose brightness has been improved by a bleaching treatment is also useful.

The following agents may be added to the raw paper sheet as necessary: a sizing agent such as a higher fatty acid and alkylketene dimer; white pigment such as calcium carbonate, talc and titanium oxide; a paper strength enhancer such as starch, polyacrylamide and polyvinyl alcohol; a fluorescent brightener; a humectant such as polyethyleneglycol; a dispersing agent; a softening agent such as quaternary ammonium; and the like.

The freeness of the pulp to be used for paper-making is preferably from 200 to 500 ml as defined in CSF. Regarding the fiber length after beating, the sum of the percentage by mass of the 24 mesh filtration residue and the percentage by mass of the 42 mesh filtration residue is preferably 30 to 70 mass %. Such mesh filtration residues are defined in JIS P-8207, which is incorporated herein by reference. The percentage by mass of the 4 mesh filtration residue is preferably 20 mass % or less.

The basis weight of the raw paper is preferably from 30 to 250 g/m², particularly preferably from 50 to 200 g/m². The thickness of the raw paper is preferably from 40 to 250 μm. High smoothness can be rendered to the raw paper by applying a calender treatment during paper making or after paper making. The density of the raw paper is usually from 0.7 to 1.2 g/m³ (JIS P-8118, which is incorporated herein by reference).

The rigidity of the raw paper is preferably from 2 to 20 mN·m under the condition according to JIS P-8125, which is incorporated herein by reference.

The surface of the raw paper sheet may be coated with a surface sizing agent, which may be selected from the above-described examples of sizing agents that can be incorporated into the interior of the raw paper.

The pH of the raw paper is preferably from 5 to 9 when measured by a hot water extraction method according to JIS P-8113, which is incorporated herein by reference.

While polyethylene used for coating the front and back surfaces of the raw paper may contain, as a main component, a low density polyethylene (LDPE) and/or a high density polyethylene (HDPE). However, LLDPE, polypropylene, and the like may also be used as a component.

The polyethylene layer on the side to be provided with the ink-receiving layer is preferably obtained by adding titanium oxide of rutile or anatase type, fluorescent brightener and ultramarine blue to polyethylene such that opaqueness, whiteness, and hue are improved, as widely adopted in photographic paper. The content of titanium oxide relative to polyethylene is preferably from 3 to 20 mass %, more preferably from 4 to 13 mass %. While the thickness of the polyethylene layer is not particularly restricted, a thickness of 10 to 50 μm is favorable for both the layers on the front and back sides. An undercoat layer may be provided on the polyethylene layer so as to provide the polyethylene layer with adhesiveness to the ink-receiving layer. Aqueous polyester, gelatin and PVA are preferable as the undercoat layer. The thickness of the undercoat layer is preferably from 0.01 to 5 μm.

The polyethylene coated paper may be used as glossy paper, or may be used as paper having such a matte surface or silky surface as realized in usual photographic paper if a so-called embossing treatment is conducted when polyethylene is coated on the raw paper by melt-extrusion.

A back coat layer may be provided on the support, and components that can be added to the back coat layer may be, for example, a white pigment, an aqueous binder and the like.

Examples of the white pigment contained in the back coat layer include inorganic white pigments such as light calcium carbonate, heavy calcium carbonate, kaolin, talc, calcium sulfate, barium sulfate, titanium dioxide, zinc oxide, zinc sulfide, zinc carbonate, satin white, aluminum silicate, diatomaceous earth, calcium silicate, magnesium silicate, synthetic amorphous silica, colloidal silica, colloidal alumina, pseudo-boehmite, aluminum hydroxide, alumina, lithopone, zeolite, hydrated halloysite, magnesium carbonate and magnesium hydroxide; and organic pigments such as styrene-based plastic pigments, acrylic plastic pigments, polyethylene, microcapsules, urea resin and melamine resin.

Examples of the aqueous binder usable in the back coat layer include water-soluble polymers such as styrene/maleic acid salt copolymer, styrene/acrylic acid salt copolymer, polyvinyl alcohol, silanol-modified polyvinyl alcohol, starch, cationized starch, casein, gelatin, carboxymethyl cellulose, hydroxyethyl cellulose and polyvinyl pyrrolidone; and water dispersible polymers such as styrene-butadiene latex and acrylic emulsion.

Other components that can be contained in the back coat layer include defoaming agents, foaming suppressing agents, dyes, fluorescent brighteners, antiseptics and water-proofing agent.

<Manufacturing of an Inkjet Recording Medium>

The ink-receiving layer of the inkjet recording medium according to the invention is formed preferably by a method in which, onto the coated layer formed by application of the coating liquid A containing inorganic particles, a sulfoxide compound, a cationic polymer, and a water-soluble resin onto a support, the coating liquid B having a pH exceeding 7 is applied (1) simultaneously with the application of the coating liquid A for forming the coated layer, or (2) before the coated layer exhibits decreasing drying during drying of the coated layer formed by application of the coated liquid A; and then the coated layer provided with the coating liquid B is subjected to crosslink-curing.

The water-soluble polyvalent metal compound according to the invention and the mordant that can be optionally added may be included in at least one of the coating liquid A or the coating liquid B, preferably in the coating liquid A from the viewpoint of ink absorbing property.

The cross-linking agent for crosslinking the water-soluble resin may also be included in any of the coating liquid A or the coating liquid B.

Such an ink-receiving layer formed by crosslink-curing in this manner is preferable from the viewpoints of ink absorbing property, prevention of cracking of the film, and the like.

Formation of the ink-receiving layer in this manner is preferable since the color density, the glossiness of the printed portion, the water resistance of letters and images after printing, the ozone resistance, and suppression of bleeding over time are improved. This is because sufficient amounts of the water-soluble polyvalent metal compound and the mordant are present in the predetermined portion of the ink-receiving layer, so that the inkjet colorant is mordanted sufficiently. A part of the water-soluble polyvalent metal compound and the mordant may be included in the layer that was formed on the support first. In this case, the mordant in the first layer may be the same as or different from the mordant that is provided afterwards.

In the invention, the coating liquid for forming the ink-receiving layer (coating liquid A) including at least fine particles (for example, vapor-phase-method silica) and a water-soluble resin (for example, polyvinyl alcohol) can be prepared, for example, as follows.

Namely, inorganic fine particles such as gas phase silica and a cationic polymer that serves also as a dispersant are added to water (the proportion of the silica fine particles in water is, for example, 10 to 20 mass %). The mixture is dispersed in a condition of high-speed rotation of, for example, 10000 rpm (preferably 5000 to 20000 rpm) for, for example, 20 minutes (preferably 10 to 30 minutes) by using a beads mill (for example, “KD-P” manufactured by Shima Enterprise Co., Ltd.). Thereafter, a sulfoxide-containing compound and a polyvinyl alcohol (PVA) aqueous solution are added to the dispersion liquid. The amount of PVA is, for example, such an amount that the mass of PVA is one-third of the mass of the gas phase silica. The resulting mixture is dispersed in the same rotation condition as described above, whereby the coating liquid is obtained. It is preferred to adjust the pH of the coating liquid to around 9.2 with aqueous ammonia or the like, or to use a dispersing agent in order to render stability to the coating liquid. The resulting coating liquid is in a homogeneous sol state. When the coating liquid is applied onto a support by the following coating method, and is dried, a porous ink-receiving layer having a three-dimensional network structure can be formed.

When the water dispersion containing the gas phase silica and the dispersing agent is prepared, a previously-prepared water dispersion of the gas phase silica may be added to an aqueous solution of the dispersing agent, or an aqueous solution of the dispersing agent may be added to a water dispersion of the gas phase silica, or they may be mixed simultaneously. As an alternative, powder of the gas phase silica may be added to the aqueous solution of the dispersing agent, instead of the water dispersion of the gas phase silica.

In an embodiment, after the gas phase silica and the dispersing agent are mixed, the mixture liquid is treated with a disperser, so that the particle size is reduced to give a water dispersion containing particles with an average particle diameter of 50 nm or less.

Although the dispersing machine used for obtaining the water dispersion can be any type of conventionally known dispersing machines such as a high-speed rotation dispersing machine, a medium stirring type dispersing machine (such as a ball mill, a sand mill, and a bead mill), an ultrasonic wave dispersing machine, a colloid mill dispersing machine, and a high pressure dispersing machine, a medium stirring type machine, a colloid mill machine, and a high pressure dispersing machine are preferable from the viewpoint of effectively dispersing aggregated fine particles.

The solvent used in each process may be water, an organic solvent or a mixture of liquids selected from water and organic solvents. Organic solvents usable for coating include alcohols such as methanol, ethanol, n-propanol, i-propanol and methoxypropanol, ketones such as acetone and methylethyl ketone, tetrahydrofuran, acetonitrile, ethyl acetate and toluene.

A dispersing agent may be added for improving dispersibility of the coating liquid. The dispersing agent is not particularly limited, and may be a known cationic dispersing agent.

The amount of the dispersing agent to be added is preferably from 0.1 to 30%, more preferably from 1 to 10%, relative to the amount of the fine particles.

The pH of the coating liquid is not particularly restricted, and is preferably from 2 to 6, more preferably from 3 to 5. Bleeding of image over time can be suppressed when the ink-receiving layer is formed from the coating liquid having a pH of 2 to 6.

The ink-receiving layer coating liquid can be applied by a known coating method using, for example, an extrusion die coater, an air doctor coater, a blade coater, a rod coater, a knife coater, a squeeze coater, a reverse roll coater or a bar coater.

The liquid B may be applied onto the coated layer simultaneously with or after the application of the coating liquid for forming an ink-receiving layer (liquid A). The liquid B may be applied before the coated layer exhibits decreasing drying during drying of the coated layer. More specifically, the ink-receiving layer is suitably manufactured by introducing the liquid B during constant drying of the coated layer after the application of the coating liquid for forming an ink-receiving layer (liquid A). The liquid B may contain a mordant.

The expression “before the coated layer exhibits decreasing drying rate” usually refers to a process within a few minutes from immediately after the application of the coating liquid for forming an ink-receiving layer, during which a phenomenon, “constant drying rate”, is observed. The constant drying rate refers to a proportional decrease in content of the solvent (dispersion medium) in the coated layer to time. The time during which the “constant drying rate” is observed is described, for example, in “Kagaku Kogaku Binran (Handbook of Chemical Engineering) (pages 707 to 712, published from Maruzen Co., Ltd. on Oct. 25, 1980).

As described above, the coated layer is dried after the liquid A is applied until the coated layer exhibits a constant rate of drying. In general, the drying is carried out at 40 to 180° C. for 0.5 to 10 minutes (preferably 0.5 to 5 minutes). The drying time naturally differs depending on the amount of the coating liquid to be applied, but the above range is usually preferable.

Examples of the method for applying the liquid B before the first coated layer exhibits a decreasing drying rate include (1) a method of further applying the liquid B onto the coated layer; (2) a method of spraying the liquid B with a spray or the like; (3) a method of immersing the support having the coated layer provided thereon in the liquid B, and the like.

The method usable for applying the liquid B in the method (1) may be a known coating method such as methods using a curtain flow coater, an extrusion die coater, an air doctor coater, a blade coater, a rod coater, a knife coater, a squeeze coater, a reverse roll coater or a bar coater. However, methods in which the coater does not directly contact the already formed first coated layer are preferable, such as an extrusion die coater, a curtain flow coater and a bar coater.

After applying the liquid B, the ink-receiving layer is usually heated to 40 to 180° C. for 0.5 to 30 minutes so as to be dried and cured. Heating to 40 to 150° C. for 1 to 20 minutes is particularly preferable.

When the liquid B is applied simultaneously with the application of the coating liquid for forming the ink-receiving layer (liquid A), the liquid A and liquid B may be simultaneously applied (dual layer coating) onto the support such that the liquid A contacts the support, and then are dried and cured to form the ink-receiving layer.

The simultaneous application (dual layer coating) can be performed by a coating method using, for example, an extrusion die coater or a curtain flow coater. The resultant coated layer is dried after the simultaneous application. The drying is conducted usually by heating the coated layer to 40 to 150° C. for 0.5 to 10 minutes, preferably to 40 to 100° C. for 0.5 to 5 minutes.

When the simultaneous application (dual layer coating) is conducted, for example with an extrusion die coater, the simultaneously extruded two coating liquids form a dual layer in the vicinity of the discharge port of the extrusion die coater before being transferred onto the support, and the dual layer is applied onto the support as it is. Since the two coating liquids in the dual layer before application already tend to cause crosslinking reaction at the interface between the two coating liquids during transfer onto the support, the extruded two liquids are likely to mix and become viscous in the vicinity of the discharge port of the extrusion die coater, in which case, application operation are sometimes troublesome. Accordingly, when the simultaneous coating is conducted as described above, it is preferable to further provide a barrier layer liquid (an intermediate layer liquid) between the coating liquid A and the coating liquid B at the time of the application of the liquid A or liquid B, so as to form a triple layer.

The barrier layer liquid may be selected without particular restrictions, and may be, for example, an aqueous solution containing a trace amount of water-soluble resin, or water. The water-soluble resin is added as a thickener in consideration of coatability. The water-soluble resin may be a polymer, whose examples include cellulose resins (such as hydroxylpropylmethyl cellulose, methyl cellulose and hydroxyethylmethyl cellulose), polyvinyl pyrrolidone and gelatin. The barrier layer liquid may contain a mordant such as those described above.

The surface smoothness, glossiness, transparency and coated layer strength can be improved by applying a calender treatment by passing through a roll nip under heat and pressure using a super calender or a gloss calender after forming an ink-receiving layer on a support. However, since the calender treatment may cause a decrease of the void ratio (, which may result in decrease in ink absorbing property), a condition giving smaller decrease in the void ratio should be employed.

The roll temperature at the calender treatment is preferably from 30 to 150° C., more preferably from 40 to 100° C.

The linear pressure between the rolls at the calender treatment is preferably from 50 to 400 kg/cm, more preferably from 100 to 200 kg/cm.

Since the ink-receiving layer should have an enough absorption capacity to absorb all the droplets in the ink-jet recording, the thickness of the ink-receiving layer should be determined in relation to the void ratio in the layer. For example, the thickness should be about 15 μm or more when the amount of ink is 8 nL/mm² and the void ratio is 60%.

Considering these points, the thickness of the ink-receiving layer is preferably from 10 to 50 μm in the case of ink-jet recording.

The diameter of the void in the ink-receiving layer is preferably from 0.005 to 0.030 μm, more preferably from 0.01 to 0.025 μm, in terms of a median diameter.

The void ratio and median diameter can be measured with a mercury porosimeter (trade name: PORESIZER 9320-PC2, manufactured by Shimadzu Corporation).

The pH of the surface of the ink-receiving layer of the invention is preferably from 3 to 7, more preferably from 3 to 5. The pH on the surface is measured in 30 seconds using water according to the J. TAPPI Paper and Pulp Test Method No. 49, which is incorporated herein by reference. Image storability is improved when the pH is 3 or more, while water resistance is improved when the pH is 7 or less, thereby enabling more efficient suppression of bleeding under a high humidity condition. Accordingly, resistance to bleeding over time, ozone resistance and light fastness can be improved when the pH of the surface is from 3 to 7.

The ink-receiving layer preferably has high transparency. As a rough guide, when the ink-receiving layer is formed on a transparent film support, the haze value is preferably 30% or lower, more preferably 20% or lower.

The haze value can be measured with a haze meter (trade name: HGM-2DP, manufactured by Suga Test Instrument Co., Ltd.).

A dispersion of polymer fine particles may be added to the layers constituting the inkjet recording medium according to the invention (for example, the ink-receiving layer or a back layer). This polymer fine particle dispersion is used for improving film properties such as dimensional stability, prevention of curl, prevention of adhesion and prevention of crack. The polymer fine particle dispersion is described, for example in JP-A Nos. 62-245258, 62-1316648 and 62-110066. Cracking and curling of the layer can be prevented by adding a polymer fine particle dispersion having a low glass transition temperature (40° C. or less) in the layer containing the mordant. Curling may be also prevented by adding a polymer fine particle dispersion having a high glass transition temperature to the back layer.

Exemplary embodiments of the present invention are described below.

<1> A recording medium having, on a support, a recording layer including a tartaric acid diamide derivative having an alkenyl group and/or an alkynyl group.

<2> The recording medium as described in <1>, wherein the tartaric acid diamide derivative is a tartaric acid diamide derivative represented by any one of the following formulae (1) to (3):

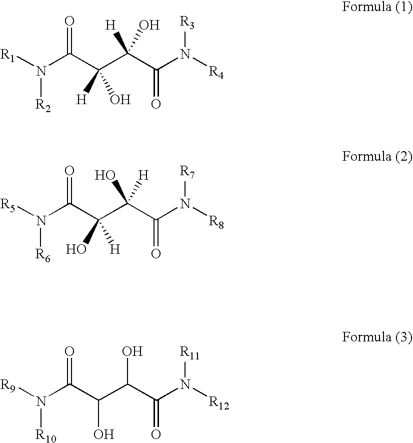

wherein, in formulae (1) to (3), R₁ to R₁₂ each independently represent a hydrogen atom, an alkenyl group having 2 to 30 carbon atoms, or an alkynyl group having 2 to 30 carbon atoms; R₁ to R₁₂ may be the same as or different from each other; at least one of R₁ to R₄ is an alkenyl group or an alkynyl group; at least one of R₅ to R₈ is an alkenyl group or an alkynyl group; and at least one of R₉ to R₁₂ is an alkenyl group or an alkynyl group; and neighboring groups selected from R₁ to R₁₂ may form a ring.

<3> The recording medium as described in <1> or <2>, wherein the recording layer is an ink-receiving layer including inorganic fine particles, and the recording medium is an inkjet recording medium.

<4> The recording medium as described in <3>, wherein the amount of the tartaric acid diamide derivative in the ink-receiving layer is 0.1 g/m² or more but less than 2.0 g/m².

<5> The recording medium as described in <3> or <4>, wherein the ink-receiving layer includes a water-soluble polyvalent metal compound and a mordant in the ink-receiving layer.

<6> The recording medium as described in any one of <3> to <5>, wherein the inorganic fine particle is a vapor-phase-method silica.

<7> The recording medium as described in <5>, wherein the water-soluble polyvalent metal compound is an aluminum compound. <8>A method for manufacturing an inkjet recording medium described in any one of <1> to <5>, the method including:

forming a coated layer by coating, on a support, a coating liquid A for forming an ink-receiving layer wherein the coating liquid A includes the tartaric acid diamide derivative having an alkenyl group and/or an alkynyl group; and

applying, so as to perform cross-linking and curing of the coated layer, a basic coating liquid B having a pH exceeding 7 onto the coated layer (i) simultaneously with the application of the coating liquid A, or (ii) before the coated layer exhibits decreasing drying during drying of the coated layer formed by application of the coated liquid A.

<9> The method as described in <8>, wherein the tartaric acid diamide derivative is a tartaric acid diamide derivative represented by any one of the formulae (1) to (3).

### EXAMPLES

The invention will be explained by reference to Examples below. In the Examples, “part” means “part by mass” and “%” means “% by mass.”

### Example 1

—Preparation of Support—

A pulp slurry was prepared by beating 50 parts of LBKP made from acacia wood and 50 parts of LBKP made from aspen wood in a disc refiner to a degree of Canadian freeness of 300 ml.

To the pulp slurry obtained above, 1.3% of a cationic starch (trade name: CATO 304L, manufactured by Nippon NSC), 0.15% of an anionic polyacrylamide (trade name: POLYACRONE ST-13, manufactured Seiko PMC Corp.), 0.29% of an alkylketene dimmer (trade name: SIZEPINE K, manufactured by Arakawa Chemical Industries. Ltd.), 0.29% of epoxidized behenic acid amide, and 0.32% of polyamide polyamine epichlorohydrin (trade name: ARAFIX 100, manufactured by Arakawa Chemical Industries. Ltd. Ltd.) were added, and then an antifoaming agent 0.12% was further added. The above percentages represent the ratios relative to the mass of the pulp.

The pulp slurry obtained above was subjected to papermaking with a Fourdrinier paper machine, and was dried by pressing the felt surface of the web to a drum dryer cylinder via a dryer canvas therebetween. During the drying, the tension on the dryer canvas was set to 1.6 kg/cm. Thereafter, both surfaces of the raw paper were coated with polyvinyl alcohol (trade name: KL-118, manufactured by Kuraray Co. Ltd.) in an amount of 1 g/m² by a size press, and were dried. Then, a calender treatment was carried out. The basis weight of the raw paper obtained was 166 g/m², and the thickness of the raw paper (base paper) was 160 μm.

After the wire surface (the back surface) of the obtained base paper was treated with corona discharge, the wire surface was coated with high-density polyethylene to a thickness of 25μm with a melt extruder to form a thermoplastic resin layer having a matte surface was formed (hereinafter, the thermoplastic resin layer surface is referred to as “the back surface”). The thermoplastic resin layer at the back surface side was treated with corona discharge, and was coated with a dispersion liquid in an amount of 0.2 g/m² in terms of a dry mass. The dispersion liquid includes aluminum oxide (trade name: ALUMINA SOL 100, manufactured by Nissan Chemical Industries Ltd.) and silicon dioxide (trade name: SNOWTEX O, manufactured by Nissan Chemical Industries Ltd.) in a mass ratio of 1:2 as antistatic agents dispersed in water.

—Preparation of Coating Liquid A for Ink-Receiving Layer—

In the composition described below, (1) vapor-phase-method silica fine particles, (2) ion-exchanged water, (3) SHAROL DC-902P, and (4) ZA-30 were mixed, and then was subjected to a dispersing treatment with a non-media type dispersing machine (for example, an ultrasonic wave dispersing machine manufactured by SMT Co. Ltd.). Thereafter, the resultant dispersion liquid was heated to 45° C. and maintained at the same temperature for 20 hours. Then, (5) boric acid, (6) polyvinyl alcohol solution, and (7) SUPERFLEX 650 described below were added to the dispersion liquid at 30° C., so that a coating liquid A for forming an ink-receiving layer was prepared.

<Composition of Coating Liquid A for Ink-Receiving Layer>

| | | | |
|---|---|---|---|
| (1) | Vapor-phase-method silica fine particles | 10.0 | parts |
| | (inorganic fine particles) (trade name: | | |
| | AEROSIL 300SF, manufactured by Nippon | | |
| | Aerosil Co. Ltd.): | | |
| (2) | Ion-exchanged water: | 62.8 | parts |
| (3) | SHAROL DC-902P, (51.5% aqueous solution) | 0.87 | part |
| | (a dispersant, manufactured by Dai-ichi Kogyo | | |
| | Seiyaku Co. Ltd.): | | |
| (4) | ZA-30 (zirconium acetate, manufactured by Dai- | 0.54 | parts |
| | ichi Kigenso Kagaku Kogyo Co. Ltd.): | | |
| (5) | Boric acid (a cross-linking agent): | 0.44 | part |
| (6) | Polyvinyl alcohol (a water-soluble resin) | 34.9 | parts |
| | solution: | | |
| (7) | SUPERFLEX 650 (manufactured by Dai-ichi | 2.47 | parts |
| | Kogyo Seiyaku Co. Ltd.) (25% water dispersion): | | |
| (8) | Tartaric acid diamide derivative A-1: | 0.25 | part |

The composition of the (6) polyvinyl alcohol solution is as follows:

| | | |
|---|---|---|
| PVA235 manufactured by Kuraray Co. Ltd., | 2.43 | parts |
| having a saponification degree of 88% and a | | |
| polymerization degree of 3500: | | |
| Polyoxyethylene lauryl ether (a surfactant, | 0.08 | part |
| trade name: EMULGEN 109P (10% aqueous | | |
| solution) having an HLB value of 13.6, | | |
| manufactured by Kao Corp.): | | |
| Diethylene grycol monobuthyl ether (trade | 0.74 | part |
| name: BUTHYSENOL 20P, manufactured by | | |
| Kyowa Hakko Chemical Co. Ltd.): | | |
| Ion-exchanged water: | 31.0 | parts |

—Preparation of Inkjet Recording Sheet—

After the front surface of the support was treated with corona discharge, the front surface was coated with coating liquid A in a coating amount of 184 ml/m². Just before the coating, a 5-fold diluted solution of polyaluminum chloride (ALFINE 83 manufactured by Taimei Chemicals Co. Ltd.) was mixed in each coating liquid to give a coating amount of the polyaluminum chloride solution of 10.8 ml/m² in an upper-layer solution. The coated layer was dried with a hot air dryer at 80° C. (with an air velocity of 3 to 8 m/sec) until the solid concentration of the coated layer became 20%. The coated layer showed a constant drying rate during the above drying process. Before the coated layer showed a decreasing drying rate, the support having the coated layer was immersed in a basic solution having the following composition for 3 seconds such that 13 g/m² of the basic solution adhered to the coated layer. Then, the support having the coated layer was dried at 80° C. for 10 minutes (curing process). As a result, an inkjet recording medium of Example 1 having an ink-receiving layer with a dry film thickness of 32 μm was obtained.

<Composition of Basic Solution A>

| | | | |
|---|---|---|---|
| (1) | Boric acid: | 0.65 | part |
| (2) | Ammonium zirconium carbonate (trade name: | 2.5 | parts |
| | ZIRCOSOL AC-7 (28% solution), manufactured | | |
| | by Dai-ichi Kigenso Kagaku Kogyo Co. Ltd.): | | |
| (3) | Ammonium carbonate (First grade; | 3.5 | parts |
| | manufactured by Kanto Chemicals Co. Ltd.): | | |
| (4) | Ion-exchanged water: | 63.3 | parts |
| (5) | Polyoxyethylene lauryl ether (a surfactant) | 30.0 | parts |
| | (trade name: EMULGEN 109P (2% aqueous | | |
| | solution) having HLB of 13.6, | | |
| | manufactured by Kao Corp.): | | |

### Examples 2 to 6

Inkjet recording media of Examples 2 to 6 were each manufactured in the same manner as in Example 1 except that the tartaric acid diamide derivative used in Example 1 was changed to the compound described in Table 1.

### Comparative Example 1

An inkjet recording medium of Comparative Example 1 was manufactured in the same manner as in Example 1 except the tartaric acid diamide derivative was not added.

### Comparative Example 2

“Photo-finishing Pro” manufactured by Fuji Photo Film Co., Ltd.

### Comparative Example 3

An inkjet recording medium of Comparative Example 3 was manufactured in the same manner as in Example 1 except the tartaric acid diamide derivative used in Example 1 was changed to B-1 described below. 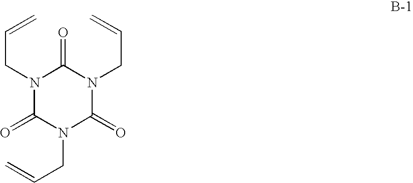
Evaluation

Evaluation of each of the inkjet recording media of Examples 1 to 6 and Comparative Examples 1 to 3 obtained above was performed with respect to the following characteristics. The results are shown in Table 1.

(1) Evaluation of Ozone Resistance

Using the inkjet printers (trade name: PIXUS950i, manufactured by Canon Inc., and trade name: PM-970C, manufactured by Epson Corp.) each equipped with a manufacturer's genuine ink set, a solid image of cyan was printed on each recording medium, and these samples were stored at 23° C., 60% RH in an environment of an ozone concentration of 1 ppm for 4 hours. The residual ratio of the cyan density after storage compared to the cyan density before storage was calculated.

(2) Evaluation of Density

Using the inkjet printer (trade name: PM-G800, manufactured by Seiko Epson Corp.) a full-color image and a black solid image were printed in a high definition mode on each recording medium, and the recording medium was stored in an environment of 23° C. and 60% RH for 24 hours. Then, the black density in the solid image part on each recording medium was measured with a transmission density meter (trade name: XRITE 310, manufactured by X-rite Co.).

TABLE 1

| | Tartaric Acid Diamide | | | | |
|---|---|---|---|---|---|
| | Derivative | | Initial Ozone Resistance | | Density |
| | | Coating | (Cyan) | | (Black) |
| | | Amount (g/m²) | PIXUS950i | PM970C | PIXUS950i |
| Example 1 | A-1 | 0.4 | 98% | 99% | 2.35 |
| Example 2 | A-2 | 0.2 | 95% | 96% | 2.34 |
| Example 3 | A-3 | 0.3 | 96% | 97% | 2.38 |
| Example 4 | A-4 | 2.0 | 99% | 100% | 2.30 |
| Example 5 | A-5 | 0.6 | 98% | 99% | 2.34 |
| Example 6 | A-6 | 0.5 | 97% | 98% | 2.34 |
| Comparative Example 1 | — | — | 82% | 83% | 2.32 |
| Comparative Example 2 | | | 84% | 86% | 2.36 |
| Comparative Example 3 | B-1 | 0.4 | 92% | 93% | 2.15 |

Residual ratio after 4 hours
in 1 ppm of ozone

As is clear from Table 1, the inkjet recording media of Examples 1 to 6 exhibited superior initial ozone resistance of cyan and a high density (black). In contrast, the inkjet recording media of Comparative Examples 1 and 2 exhibited inferior initial ozone resistance. Although the initial ozone resistance was improved in Comparative Example 3, the density (black) was low.

According to the invention, a recording medium, preferably an inkjet recording medium, can be provided which achieves improved ozone resistance, in particular the initial ozone resistance of cyan including a phthalocyanine dye or the like, and sufficient suppression of the decrease in image density by caused by ozone.

All publications, patent applications, and technical standards mentioned in this specification are herein incorporated by reference to the same extent as if each individual publication, patent application, or technical standard was specifically and individually indicated to be incorporated by reference.

What is claimed is:

1. A recording medium comprising, on a support, at least one layer that includes a tartaric acid diamide derivative having an alkenyl group and/or an alkynyl group.

2. The recording medium according to claim 1, wherein the tartaric acid diamide derivative is represented by any one of the following formulae (1) to (3): 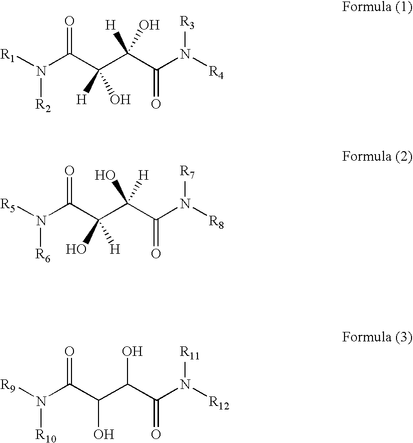
wherein, in Formulae (1) to (3), R₁ to R₁₂ each independently represent a hydrogen atom, an alkenyl group having 2 to 30 carbon atoms, or an alkynyl group having 2 to 30 carbon atoms; R₁ to R₁₂ may be the same as or different from each other; at least one of R₁ to R₄ represents an alkenyl group or an alkynyl group, at least one of R₅ to R₈ represents an alkenyl group or an alkynyl group, and at least one of R₉ to R₁₂ represents an alkenyl group or an alkynyl group; and neighboring groups selected from R₁ to R₁₂ may form a ring.

3. The recording medium according to claim 2, wherein the tartaric acid diamide derivative is represented by Formula (1), and R₁ to R₄ each independently represent a vinyl group, a propenyl group, an allyl group, an isopropenyl group, a 1-butenyl group, a 2-butenyl group, a 2-pentenyl group, a dodecenyl group, an octadecenyl group, a cyclopentenyl group, or cyclohexenyl group.

4. The recording medium according to claim 2, wherein the tartaric acid diamide derivative is represented by Formula (2), and R₅ to R₈ each independently represent a vinyl group, a propenyl group, an allyl group, an isopropenyl group, a 1-butenyl group, a 2-butenyl group, a 2-pentenyl group, a dodecenyl group, an octadecenyl group, a cyclopentenyl group, or cyclohexenyl group.

5. The recording medium according to claim 2, wherein the tartaric acid diamide derivative is represented by Formula (3), and R₉ to R₁₂ each independently represent a vinyl group, a propenyl group, an allyl group, an isopropenyl group, a 1-butenyl group, a 2-butenyl group, a 2-pentenyl group, a dodecenyl group, an octadecenyl group, a cyclopentenyl group, or cyclohexenyl group.

6. A method for manufacturing an inkjet recording medium of claim 1, the method comprising:
forming a coated layer by coating, on a support, a coating liquid A for forming an ink-receiving layer wherein the coating liquid A includes the tartaric acid diamide derivative having an alkenyl group and/or an alkynyl group; and
applying, so as to perform cross-linking and curing of the coated layer, a basic coating liquid B having a pH exceeding 7 onto the coated layer (i) simultaneously with the application of the coating liquid A, or (ii) before the coated layer exhibits decreasing drying during drying of the coated layer formed by application of the coated liquid A,
wherein the tartaric acid diamide derivative is represented by any one of the following formulae (1) to (3): 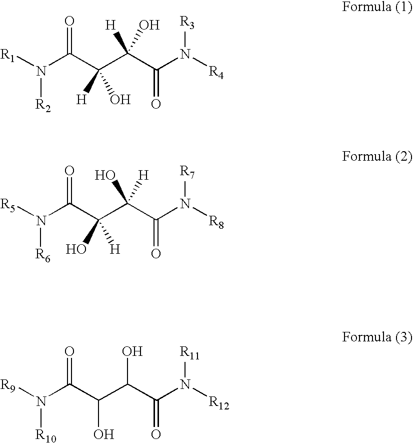
wherein, in Formulae (1) to (3), R₁ to R₁₂ each independently represent a hydrogen atom, an alkenyl group having 2 to 30 carbon atoms, or an alkynyl group having 2 to 30 carbon atoms; R₁ to R₁₂ may be the same as or different from each other; at least one of R₁ to R₄ represents an alkenyl group or an alkynyl group, at least one of R₅ to R₈ represents an alkenyl group or an alkynyl group, and at least one of R₉ to R₁₂ represents an alkenyl group or an alkynyl group; and neighboring groups selected from R₁ to R₁₂ may form a ring.

7. The method according to claim 6, wherein the tartaric acid diamide derivative is represented by Formula (1), and R₁ to R₄ each independently represent a vinyl group, a propenyl group, an allyl group, an isopropenyl group, a 1-butenyl group, a 2-butenyl group, a 2-pentenyl group, a dodecenyl group, an octadecenyl group, a cyclopentenyl group, or cyclohexenyl group.

8. The method according to claim 6, wherein the tartaric acid diamide derivative is represented by Formula (2), and R₅ to R₈ each independently represent a vinyl group, a propenyl group, an allyl group, an isopropenyl group, a 1-butenyl group, a 2-butenyl group, a 2-pentenyl group, a dodecenyl group, an octadecenyl group, a cyclopentenyl group, or cyclohexenyl group.

9. The method according to claim 6, wherein the tartaric acid diamide derivative is represented by Formula (3), and R₉ to R₁₂ each independently represent a vinyl group, a propenyl group, an allyl group, an isopropenyl group, a 1-butenyl group, a 2-butenyl group, a 2-pentenyl group, a dodecenyl group, an octadecenyl group, a cyclopentenyl group, or cyclohexenyl group.
